(19) United States
(12) Patent Application Publication
(10) Pub. No.: US 2013/0174656 A1
(43) Pub. Date: Jul. 11, 2013

(54) Tell-tale brake pad

(71) Applicant: Winston MacKelvie, Knowlton (CA)

(72) Inventor: Winston MacKelvie, Knowlton (CA)

(21) Appl. No.: 13/694,796

(22) Filed: Jan. 7, 2013

Related U.S. Application Data
(60) Provisional application No. 61/631,570, filed on Jan. 6, 2012.

(51) Int. Cl. F16D 66/02

(52) U.S. Cl. CPC F16D 66/02
USPC 73/121; 188/1.11 W

(57) ABSTRACT

A brake pad includes a tell-tale substance at the safe-limit thickness of the brake friction. Tell-tale additives may include: fluorescent mineral, colorant, reflective powder, odorant, magnetic or any other easily detectable material. The tell-tale may be added to existing designs of brakes or included on the plate for supply to the brake manufacturer. Dust from the tell-tale substance appears in the ambient when the brakes need to be replaced. Brake evaluation can thus be conducted quickly and easily from outside the vehicle when it is stopped by drivers, operators and safety authorities.

### FIELD OF THE INVENTION

The present invention is in the field of vehicular brakes and more particularly to a method of determining from outside the vehicle when brakes are worn to a safe-limit thickness and should therefore be serviced to maintain performance and public safety.

### BACKGROUND OF THE INVENTION

Disc brake pads and drum brake shoes or linings comprise a stiff metal backing plate with a thick layer of friction material attached to the plate that eventually reaches a dangerously thin layer unless replaced in time.

### SUMMARY OF THE INVENTION

In the instant invention, a tell-tale material is included in the brake construction. A tell-tale is “a reference indicator or a sign that clearly signals that something else is true or is about to happen”—Wikipedia.

Over time, as the friction is ablated away (wears away) the safe-limit of thickness of friction is reached at which time the tell-tale substance is also ablated and released to the ambient. The brake dust containing the tell-tale can therefore be detected in the ambient, as in while walking around the vehicle. For example the common ultraviolet flashlight will reveal from the standing position any fluorescent-based tell-tale. In this way a brake safety check can be done without the time consuming expense of raising a vehicle and removing the wheel for direct visual brake inspection. Such fast brake safety checks can be routinely and randomly done by safety officials at the side of the road, in parking lots, drive-throughs and the like.

The tell-tale substance may be contained in the safe-limit thickness of remaining friction or added as a separate component to the friction or to the backing plate or both. Tell-tale substances may include those that leave a colour (iron oxide), odour (pyrite), luminosity/reflectivity (metallic particles), or are magnetic (magnetite) or are attracted to a magnet (iron), radioactivity, or any combination thereof. In the case of a magnetic-based tell-tale, one or more magnets may be mounted near the brake (i.e., as a wheel balance weight) to accumulate the tell-tale dust for faster detection. For odour-based tell-tale there need not be any search for physical dust but the smell alone will suffice.

### BRIEF DESCRIPTION OF THE DRAWINGS

FIG. 1 shows a face or front view of brake pad with the friction the backing plate and five embodiments of the instant invention: one has the tell-tale substance added at the base of a slot or cross hole in the friction; a second where it is a separate pad attached to the plate; a third where it is moulded into or inserted through holes in the plate; a fourth where it is inserted down into a hole in the friction; a fifth where the plate manufacturer adds the tell-tale;

FIG. 2 shows an edge view of the same embodiments;

FIG. 3 shows an edge view where the tell-tale substance is moulded along with the regular composition friction as a distinct layer adjacent the plate;

FIG. 4 shows the same embodiment but where the normal friction has worn away to the layer of tell-tale which then produces the tell-tale dust for detection in the ambient;

FIG. 5 shows how a vehicle structure such as a wheel, receives a build-up of deposited tell-tale dust on its spokes or on added magnets when the safe-limit thickness is reached or even somewhat before that thickness;

FIG. 6 shows an embodiment where the backing plate may be manufactured with tell-tale attached outboard of the friction pad or at a site where it will become imbedded near to the outer edge of the friction pad; and

FIG. 7 is the same embodiment from the side.

### DETAILED DESCRIPTION OF THE INVENTION

Referring to the drawings, brake 100 has an ablatable or wearable layer of friction 2 attached to a backing plate 1. Brake 100 is one of two that squeeze a disc rotating between them. Brake 100 also represents brake shoes or brake linings used in drum brakes which have ring-like circular frames to hold the friction (not shown). Drum brakes are often found on heavy vehicles that operate in gritty environments and for braking the rear wheels of some lower-cost road vehicles.

As friction 2 ablates or wears away it naturally produces dust that is released to the ambient. Friction 2 is thus constantly reduced in thickness and eventually reaches a ‘safe-limit thickness’ at which point the brakes need replacing to maintain braking performance and hence public safety.

Referring to the drawings, backing plate 1 has friction 2 bonded thereto. It is shown ablated or worn away to the safe-limit thickness 12 in FIG. 4. In the instant invention there is also a tell-tale substance that begins to produce brake dust when the safe-limit thickness 12 is reached. This tell-tale may be added to the brake pad in numerous ways and in different locations.

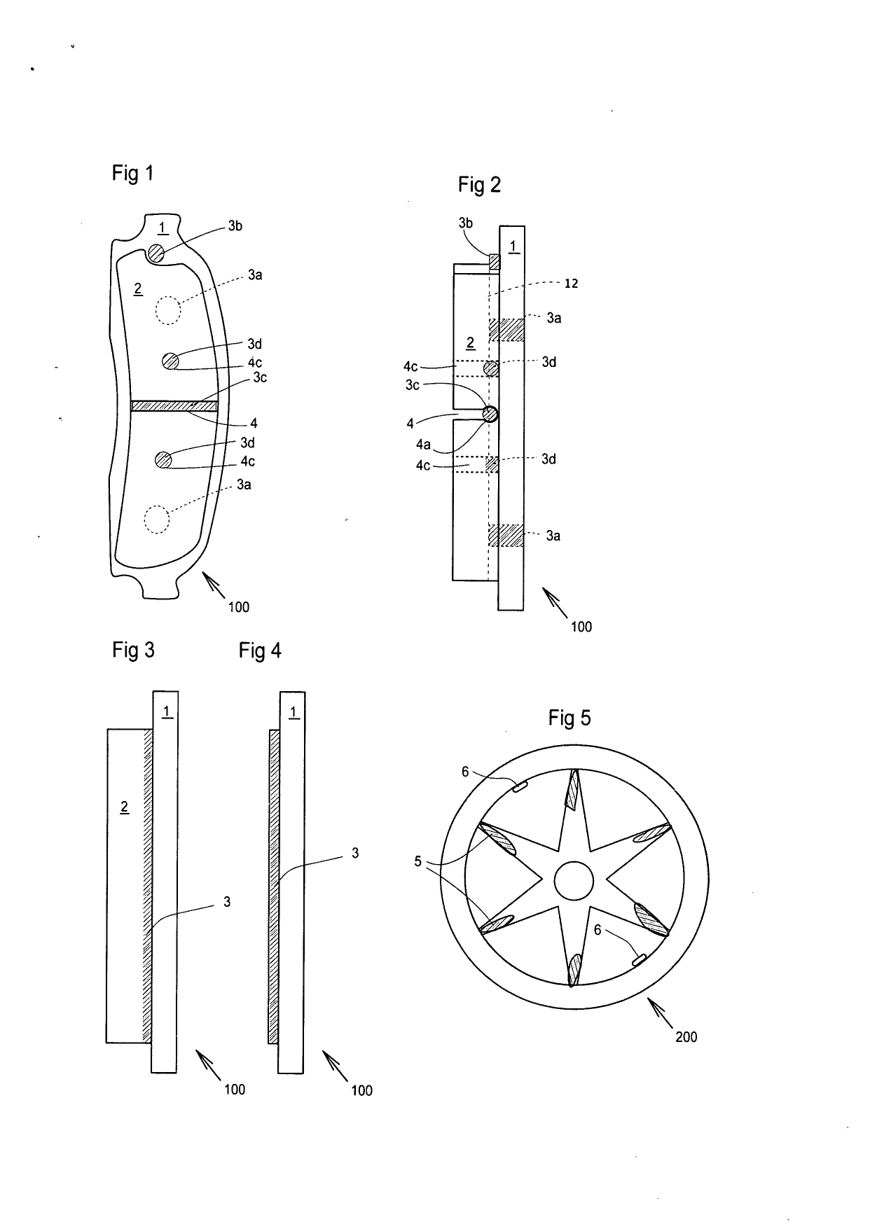

In FIGS. 1-7 at the safe-limit thickness 12 and below, ablation of the added tell-tale 3, 3a, 3b, 3c, 3d, 3e, 3f begins. Of course it could begin earlier to provide early warning of brake wear. Tell-tale dust 5 will begin to be detectable in the ambient as shown by way of example as deposits on wheel 200 in FIG. 5. In this way worn out brakes can be identified from outside the vehicle when it is stopped or parked.

In FIG. 1 tell-tale 3b is a separate pad or puck attached to plate 1 extending up only a short height to the safe-limit thickness 12. Tell-tale 3a is contained in one or more receptacles formed in plate 1. Such receptacles in the form of holes are commonly used to anchor, or key, friction 2 to plate 1. In this embodiment the tell-tale 3a again extends into the friction 2 to the safe-limit thickness 12.

In FIG. 2 tell-tale 3c is shown as an addition to a normal brake pad where tell-tale 3c is inserted down into a prepared slot 4, or a hole or other receptacle shape (not shown). The tell-tale 3c may be pre moulded to fit tightly in slot 4 or have keying features associated therewith (not shown). FIG. 2 shows in edge view of how a hole 4a formed crosswise through friction 2 can be used to hold a rod shaped tell-tale 3c inserted from the side. This may be a moulded hole of any shape to receive a similarly shaped tell-tale rod or bar. In FIG. 3 tell-tale 3 is a layer of friction 2 adjacent plate 1.

Magnets 6 may also be used in conjunction with a magnetic tell-tale such as iron dust or particular minerals. The resulting tell-tale dust 5 will accumulate on or in the magnets for amplifying the presence of the tell-tale dust 5. Such magnets could be used as balancing weights or simply added in opposing pairs so as to maintain wheel balance. The magnet may also be carried on a stick by the brake inspector to attract tell-tale for detection by moving it about the stopped vehicle's wheel regions.

In the case of tell-tale detection by odour, there may be no accumulated tell-tale dust 5 but rather a very distinguishable smell. For example if pyrite is used as the tell-tale substance then a highly unusual smell will result and will become more prominent as more and more area of the tell-tale is exposed for ablation. Of course odour and another tell-tale substance may be combined for a dual effect.

In FIGS. 1 and 2 tell-tale 3d is shown as either a ball, puck or block inserted into a hole 4c. This embodiment allows for existing brake pads to be modified by a service garage by simply drilling a hole down through friction 2 and pressing in the pre-formed tell-tale. Using a shaped tell-tale 3d will also make for increasing dust volume as it wears away exposing a larger cross-sectional shape that ablates into more tell-tale dust 5.

In FIGS. 3 and 4 is shown how tell-tale 3 is in the form of a layer of friction 2. That is tell-tale 3 may be added as a dispersion to the regular friction whereby two deposits of uncured friction material are added to the brake pad forming mold: the first deposit of friction adjacent the plate constitutes the safe-limit thickness 12 and it contains some percentage of tell-tale 3 substance in its composition; the main deposit of normal friction fills the mold.

FIG. 4 shows the result of braking where the normal friction 2 has ablated down to that safe-limit thickness 12 and the remaining friction layer contains tell-tale 3.

Tell-tale substances 3, 3a, 3b, 3c, 3d, 3e, 3f may be in different physical forms such as a loose powder or encapsulated in glass microspheres, and added as a constituent to the raw (uncured) friction composition. For other methods of inclusion in a brake pad it may be a separate component formed or molded into geometric shapes suitable for incorporating in any of various locations.

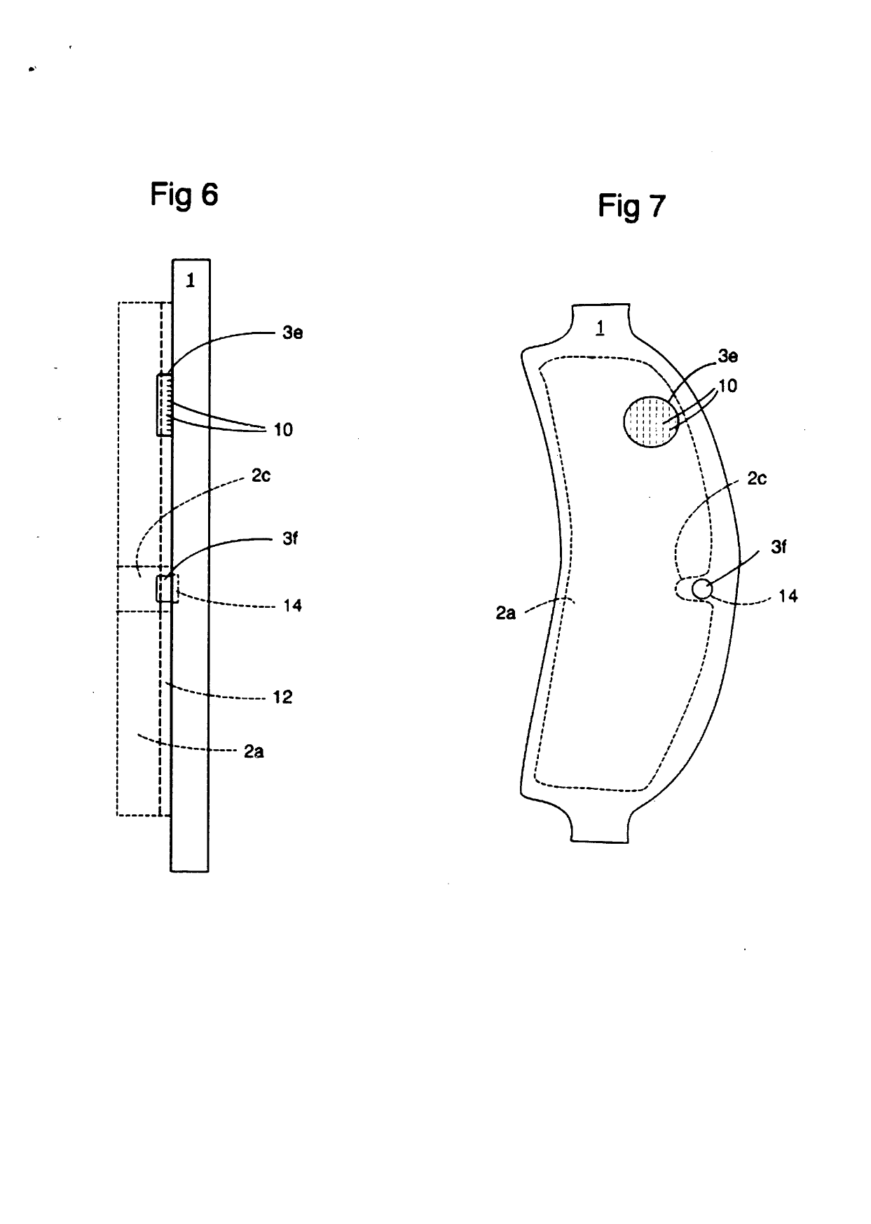

In FIGS. 6 and 7 shows how tell-tale 3e may be sited to optimize its effect by being sited nearest the outer edge so that its effect is maximized by minimizing distance to the ambient and thereby avoiding its dilution. Such outboard siting is preferably accomplished using a cut-out 2c feature in friction 2a wherein is attached tell-tale 3f that is free to disperse to the ambient. also reduces any negative friction effects the tell-tale might have by avoiding it coming between the friction and the rotor. Tell-tale 3e may also be assembled onto the backing plate 1 as part of the plate's manufacture and supplied to the friction company whereafter they over-mould the tell-tale-plate with normal friction. Dashed line 2a represents where the final friction 2 would be moulded on plate 1. Dashed line 12 represents the safe-limit thickness of friction 2. Tell-tale 3e is as a puck and has a thickness that approximates the safe-limit thickness 12. Tell-tale 3e has recesses on the plate side of the puck shape that are pre-moulded so as to engage features 10 raised from the plate 1. Such raised features are well-known in the brake plate industry and are used to key the friction to the plate so as to resist shear forces. Such features include raised burrs produced by short-stroke toothed blades and pin-like structures punch-pressed up from the opposite side of the plate. Adhesive bonds puck 3e to features 10 and thus to plate 1. In another embodiment a shaped recess 14 may be formed in plate 1 and a matching shape of tell-tale 3f bonded therein. In these ways a tell-tale enhanced plate can ship to the brake manufacturer ready for over-moulding with friction using current manufacturing processes.

In another embodiment, if any tell-tale 3a, 3b, 3c, 3d, 3e, 3f is odour producing, it may be over-coated with an thermally insulative layer to prevent premature leaching of smell to the ambient as a result of high heat brake operation.

Although the invention has been shown and described with respect to detailed embodiments thereof, it should be understood by those skilled in the art that various changes in form and detail thereof may be made without departing from the spirit and the scope of the claimed invention.

I claim:

1. The improvement to a brake pad, said brake pad comprising a backing plate with friction secured thereto, and where in use said friction ablates to dust into the ambient, and where said ablation reduces said friction to a safe-limit thickness, the improvement comprising:
including an ablatable tell-tale substance within at least said safe-limit thickness such that said tell-tale is detectable in the ambient when said safe-limit thickness of said friction is reached.

2. The improvement of claim 1 wherein said tell-tale has magnetic properties and at least one magnet collects at least some of said tell-tale.

3. The improvement of claim 1 wherein said tell-tale has colour properties.

4. The improvement of claim 1 wherein said tell-tale has fluorescent properties.

5. The improvement of claim 1 wherein said tell-tale has an odoriferous property.

6. The improvement of claim 1 wherein said tell-tale has a reflective property.

7. The improvement of claim 1 wherein said tell-tale has a radioactive property.

8. A method of detecting the safe-limit thickness of brake friction in a vehicular brake system comprising the steps of:
including an ablatable tell-tale in said brake system;
said ablatable tell-tale becoming evident in the ambient when said safe-limit thickness of said brake friction is reached.

9. A brake plate having a tell-tale substance thereon.
